(19) United States
(12) Patent Application Publication
(10) Pub. No.: US 2015/0137753 A1
(43) Pub. Date: May 21, 2015

(54) CHARGING DEMAND VERIFICATION METHOD OF -ECO-FRIENDLY VEHICLE AND SYSTEM USED THEREIN

(71) Applicants: Hyundai Motor Company, Seoul (KR); AJOU UNIVERSITY INDUSTRY - ACADEMIC COOPERATION FOUNDATION, Suwon-si (KR)

(72) Inventors: Kang Ju CHA, Seoul (KR); Ji Hwon KIM, Gwangmyeong-si (KR); So Jin LEE, Seoul (KR); Tae Shik SHON, Suwon-si (KR)

(73) Assignees: HYUNDAI MOTOR COMPANY, Seoul (KR); AJOU UNIVERSITY INDUSTRY - ACADEMIC COOPERATION FOUNDATION, Suwon-si (KR)

(21) Appl. No.: 14/283,854

(22) Filed: May 21, 2014

(30) Foreign Application Priority Data
Nov. 19, 2013 (KR) 10-2013-0140346

(51) Int. Cl. B60L 11/18

(52) U.S. Cl. CPC B60L 11/1848; B60L 11/1846
USPC 320/109

(57) ABSTRACT

In a charging demand verification method of an eco-friendly vehicle (EV), an eco-friendly vehicle supply equipment (EVSE) receives a charging request from a communication controller of eco-friendly vehicle (EVCC). The EVSE receives an identification code value (PEVID), a moving distance value, and a request charging value from the EVCC. The EVSE transmits the received identification code value to a secondary actor (SA). The EVSE receives vehicle type information, a basic maximum charging value, an accumulated moving distance value, and a charging amount at a previous charging time. The EVSE compares the request charging value and denies the charging request of the EV when the request charging value is greater than the basic maximum charging value. The EVSE calculates a prediction value of power consumed by the EV, and charges the EV when the difference between the prediction value and the actual power value actually is within a predetermined error range.

### CROSS-REFERENCE TO RELATED APPLICATION

This application claims under 35 U.S.C. §119(a) the benefit of priority to Korean Patent Application No. 1 0-201 3-01 40346 filed Nov. 19, 2013, the entire contents of which are incorporated herein by reference.

### TECHNICAL FIELD

The present disclosure relates to a method for verifying a charging amount required by an eco-friendly vehicle (EV), thereby preventing the eco-friendly vehicle from maliciously attempting to overcharge the vehicle, and a system used in the method.

### BACKGROUND

Eco-friendly vehicles obtain energy for driving from electric energy rather than by burning fossil fuel in existing vehicles, i.e., by charging electric energy to a battery. The term, an eco-friendly vehicle used herein, includes both an electric vehicle and a hybrid vehicle.

However, the cost for charging an eco-friendly vehicle varies depending on to which receiving terminal the electricity is supplied to a process of charging electric energy. Charging rate for electric energy being used may vary depending on which receiving terminal supplies the electricity to, complying with the national policy for conserving energy while preventing disparities in distribution. For example, in the U.S., the electricity rate system is subdivided into those for home, industry, commerce, etc., and the electricity rate differs from state to state. In Korea, the electricity rate varies depending on each receiving terminal. In the case of electricity for home use, the electricity rate is imposed in proportion to the amount of electricity used.

Therefore, a driver using an eco-friendly vehicle is easily tempted to charge, and in face, charges the eco-friendly vehicle in an industrial or commercial facility, etc., where the electricity rate is relatively cheaper.

In order to solve such a problem, it has been proposed to impose a separate rate on charging of an eco-friendly vehicle through a separate meter for charging at home or to set a rate system where an off-peak rate is applied in a specific time zone.

However, such proposals do not consider whether or not an eco-friendly vehicle may request a larger amount of charging electric energy to charge a separate electric device such as a refrigerator or air conditioner besides the eco-friendly vehicle. This is because the rate of electric energy used in charging of the eco-friendly vehicle is cheaper than that of electricity for home use.

Similarly, above mentioned problems have not been considered in ISO/IEC 15118 which is the eco-friendly vehicle charging process standard. According to ISO/IEC 15118 standard, the maximum charging value (ChargingProfileEntryMaxPower) of a charging profile is of a string type as shown in FIG. 5. Therefore, the maximum charging value (ChargingProfileEntryMaxPower) may be arbitrarily corrected.

That is, an eco-friendly vehicle (EV) provides items shown in FIG. 6 to an eco-friendly vehicle supply equipment (EVSE) in the ISO/IEC 15118 standard. Values including a state of the EV (PEVStatus), a charging method (ChargingMode), end of charging (EoC), an energy content requested by the EV (Eamount) may be arbitrarily modified. Accordingly, the EV may obtain electric energy beyond the charging amount requested by the EV from the EVSE and may use the electric energy for private purposes.

### SUMMARY OF THE DISCLOSURE

The present disclosure provides a charging demand verification method of an eco-friendly vehicle (EV) and a system used therein, which can prevent the EV from maliciously charging the maximum amount or more beyond a charging amount to charge the EV.

According to an exemplary embodiment of the present disclosure, a charging demand verification method of an eco-friendly vehicle (EV) includes receiving, by an eco-friendly vehicle supply equipment (EVSE), a charging request from a communication controller of eco-friendly vehicle (EVCC). An identification code value (PEVID), a moving distance value, and a request charging value (ChargingProfileMaxPower) are received from the EVCC by the EVSE. The received identification code value is transmitted to a secondary actor (SA) by the EVSE. Vehicle type information, a basic maximum charging value (ChargingProfileEntryMaxPower), an accumulated moving distance value, and a charging amount at a previous charging time are received from the SA by the EVSE. The request charging value received from the EVCC of the EV is compared with the basic maximum charging value received from the SA by the EVSE. The charging request of the EV is denied by the EVSE when the request charging value is greater than the basic maximum charging value, and a next process proceeds when the request charging value is smaller than the basic maximum charging value. A prediction value of power consumed by the EV is calculated by the DVSE using the mile per gallon (MPG) of the vehicle type information received from the SA, the accumulated moving distance value at the previous charging time, and the moving distance value received from the EVCC of the EV. The EV is charged by the EVSE when a difference between the prediction value of the power consumed by the EV and power actually consumed by the EV is within a predetermined error range.

The calculation of the prediction value of the power consumed by the EV, using the MPG of the vehicle type information received from the SA, the accumulated moving distance value at the previous charging time, and the moving distance value received from the EVCC of the EV may include calculating a difference value between the moving distance value received from the EV and the accumulated moving distance value at the previous charging time received from the SA. The prediction value of the power consumed by the EV is calculated by dividing the MPG of the vehicle type information into the difference value.

The method may further include after charging the EV when the difference between the prediction value of the power consumed by the EV and the power actually consumed by the EV is within the predetermined error range, transmitting, by the EVSE, the amount of power charged in the EV and a moving distance value in the charging of the EV to the SA. The moving distance value in the charging of the EV is transmitted to the EV by the EVSE.

According to another exemplary embodiment of the present disclosure, a charging demand verification method of an eco-friendly vehicle (EV) includes receiving, by a secondary actor (SA), an identification code value (PEVID) transmitted from an eco-friendly vehicle supply equipment (EVSE) which charges power in the

EV. Vehicle type information of the corresponding EV, a basic maximum charging value (ChargingProfileEntryMaxPower), an accumulated moving distance value, and a charging amount at a previous charging time are transmitted to the EVSE by the SA according to the identification code value of the EV. The amount of power charged in the EV and a moving distance value in the charging of the EV, which are transmitted from the EVSE, are received by the SA.

According to another exemplary embodiment of the present disclosure, a charging demand verification method of an eco-friendly vehicle (EV) includes transmitting, by an communication controller of eco-friendly vehicle (EVCC) of the EV, a charging request to an eco-friendly vehicle supply equipment (EVSE) An identification code value (PEVID), a moving distance value, and a request charging value (ChargingProfileMaxPower) are transmitted to the EVSE by the EVCC. The EV is charged by receiving power supplied from the EVSE. A moving distance value in the charging of the EV is received from the EVSE by the EVCC when the charging of the EV is completed. The moving distance value in the charging of the EV is stored in a memory by the EVCC.

According to another exemplary embodiment of the present invention, a charging demand verification system of an eco-friendly vehicle (EV) includes the EV configured to request electric energy to be charged therein. An eco-friendly vehicle supply equipment (EVSE) is configured to receive a charging request from a communication controller of eco-friendly vehicle (EVCC) of the EV, decide whether the charging request requests power actually consumed by the EV, and supply electric energy to the EV when the charging request is a legal charging request. A secondary actor (SA) is configured to store vehicle type information corresponding to an identification code value (PEVID) of the EV that transmits the charging request to the EVSE and an accumulated moving distance value and a charging amount at a previous charging time. The SA transmits the vehicle type information, the accumulated moving distance value, and the charging amount at the previous charging time to the EVSE according to the charging request of the EV.

Other aspects and exemplary embodiments of the disclosure are discussed infra.

As described above, the charging demand verification method of the EV and the system used therein have advantages as follows.

It is possible to prevent the EV from maliciously charging electric energy to other electronic devices by requesting a charging amount more than the maximum value or more. In addition, although the charging profile of the EV is arbitrarily manipulated, the charging allowance amount of the EV can be calculated using information provided from the SA, so that it is possible to prevent the EV from being maliciously overcharged.

The above and other features of the disclosure are discussed infra.

### BRIEF DESCRIPTION OF THE DRAWINGS

The above and other features of the present disclosure will now be described in detail with reference to certain exemplary embodiments thereof illustrated by accompanying drawings which are given hereinbelow by way of illustration only, and thus are not limitative of the present disclosure.

FIG. 1 is a diagram illustrating an environment in which a charging method of an eco-friendly vehicle (EV) is used according to an exemplary embodiment of the present disclosure.

FIG. 2 is a flowchart illustrating a process of requesting electric energy to be charged from an eco-friendly vehicle (EV) in a charging demand verification method of the EV according to an exemplary embodiment of the present disclosure.

FIG. 3 is a flowchart illustrating a process of verifying a charging request of an eco-friendly vehicle (EV) from an electric supply equipment (EVSE) in a charging demand verification method of the EV according to an exemplary embodiment of the present disclosure.

FIG. 4 is a flowchart illustrating an operation of a secondary actor (SA) which is a backend system (BS).

FIG. 5 is a diagram illustrating a type of a maximum charging profile in ISO/IEC 15118.

FIG. 6 is a diagram illustrating items provided in a charging request of an eco-friendly vehicle (EV) in ISO/IEC 15118.

FIG. 7 is a diagram illustrating values defined in ISO/IEC 15118-2.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will now be made in detail to various embodiments of the present disclosure, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

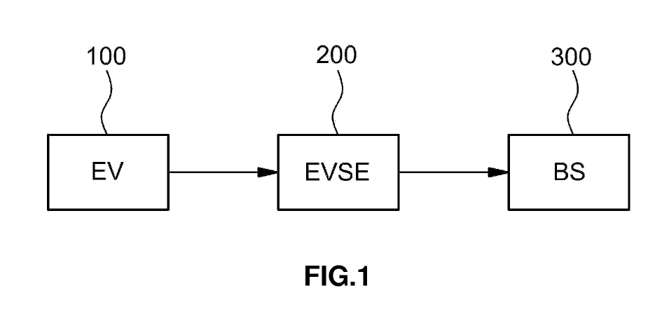

FIG. 1 is a diagram illustrating an environment in which a charging method of an eco-friendly vehicle (EV) is used according to an exemplary embodiment of the present disclosure.

First, in an exemplary embodiment of the present disclosure, the EV 100 may refer to not only a pure EV such as a battery electric vehicle (BEV) but also all vehicles that use electricity as a driving source, such as a plug-in hybrid electric vehicle (PHEV).

The EV 100 according to an exemplary embodiment of the present disclosure may be provided with a communication controller of eco-friendly vehicle (EVCC), which is not shown, to communicate with an eco-friendly vehicle supply equipment

(EVSE) 200. The EVSE may be provided with a communication controller of supply equipment (SECC), which is not shown, to communicate with an EV or backend system (BS) 300.

A charging demand verification method of the EV 100 according to an exemplary embodiment of the present disclosure will be described hereinafter. In the charging demand verification method of the EV, a charging demand of the EV 100 is verified through data exchange among the EVCC of the EV 100, the SECC of the EVSE 200 and a secondary actor (SA). However, for convenience of illustration, data communication between the EV 100 and the SA is performed in the method.

The EVSE 200 may refer to a space where electric energy necessary for the EV 100 can be supplied. This may include a spatial meaning or may indicate a certain device which supplies the electric energy. However, the present disclosure is not limited thereto. That is, all may be included in the concept of the EVSE 200 as long as they supply the electric energy to the EV 100.

The BS 300 may refer to an SA as a system which includes information necessary for charging when the EV 100 attempts to charge the electric energy in the EVSE 200. The SA may be a device such as a server which can store various information on the EV 100 in real time.

Referring to FIG. 1, in the charging demand verification method of the EV according to an exemplary embodiment of the present disclosure, the EV 100 reaches the EVSE 200 to request the EVSE 200 to charge electric energy therein. The EVSE 200 receives an identification code value (PEVID) supplied from the EV 100 and then transmits the received identification code value to the SA. The SA transmits various information on the corresponding EV 100, using the identification code value (PEVID) of the EV 100, which requests the electric energy to be charged from the EVSE 200, so that the various information can be used to verify whether the charging demand of the EV 100 is a legal charging demand.

The various information that the SA transmits to the EVSE 200 may be various values, e.g., vehicle type information, a basic maximum charging amount, an accumulated move distance value, a charging amount at a previous charging time, and the like.

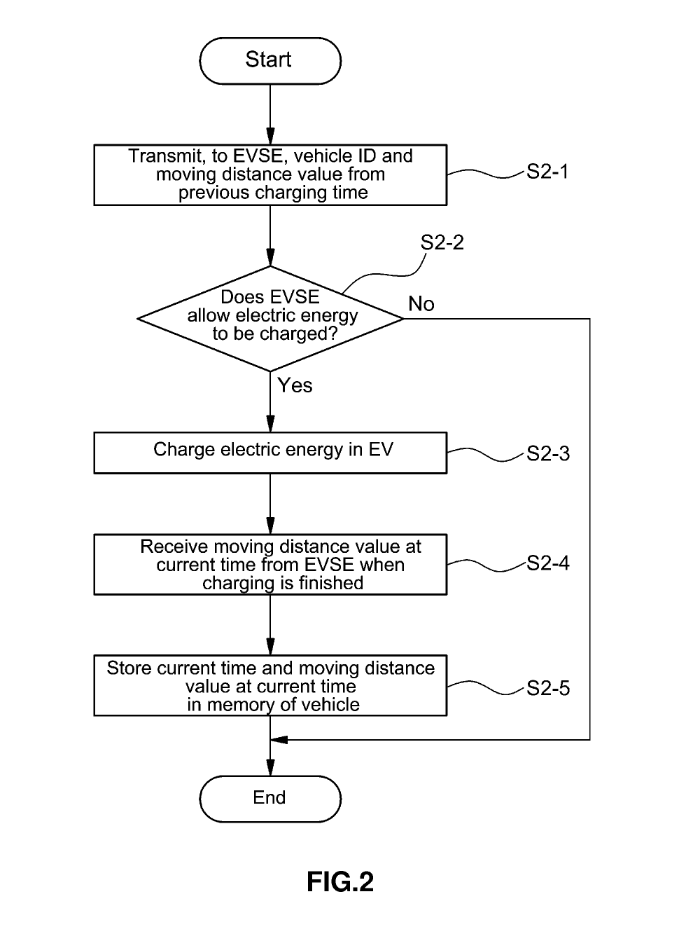

FIG. 2 is a flowchart illustrating a process of requesting electric energy to be charged from an eco-friendly vehicle (EV) 100 in a charging demand verification method of the EV 100 according to an exemplary embodiment of the present disclosure.

If the EV 100 needs to be charged while driving the EV 100, the EV 100 may visit the EVSE 200.

The EV 100 visiting the EVSE 200 may be physically connected to the EVSE 200 using a connection terminal such as a jack in order to receive electric energy supplied from the EVSE 200. Alternatively, the EV 100 may be stopped at a predetermined position of the EVSE 200 in order to receive the electric energy wirelessly.

The data exchange between the EV 100 and the EVSE 200 may be performed using a physical wiring method or may be performed using a wireless method such as Bluetooth.

When the EV 100 visits the EVSE 200, the EV 100 may transmit an identification code value (PEVID), which is an ID of the vehicle, and a moving distance value (S2-1) to the EVSE 200. The moving distance value may be a moving distance value from the time when the EV 100 was previously charged to the time when the EV 100 requests electric energy to be charged therein.

Next, the EVSE 200 may receive a response to whether the EVSE 200 allows the EV 100 to be charged with respect to a charging request of the EV 100 (S2-2). In a case where the charging request from the EV 100 to the EVSE 200 to supply the charging demand of the EV 100 is greater than the amount of electric energy consumed by the EV 100, the EVSE 200 may deny the supply of electricity to the EV 100. In this case, if the EVSE 200 denies the supply of electric energy to the EV 100, the process of charging the electric energy to the EV 100 may be finished. However, if the EVSE 200 allows the electric energy to be charged in the EV 100, the EV 100 receives the electric energy supplied from the EVSE 200 to charge a battery of the EV 100 (S2-3).

If the charging of the electric energy is completed, the EV 100 may receive a moving distance value at the current time when the charging of the electric energy from the EVSE 200 is completed (S2-4). However, the process of receiving the moving distance value may be performed by actually receiving the moving distance value from the EVSE 200 or may be performed by storing a moving distance value stored in an internal memory when the electric energy is charged in the EV 100.

If information, which can be used in verifying an electricity charging amount requested by the EV 100, exists, the EVSE 200 may additionally transmit the information to the EV 100 as well as the moving distance value when the electric energy is charged in the EV 100, so that the EVCC of the EV 100 stores the value in a memory (S2-5).

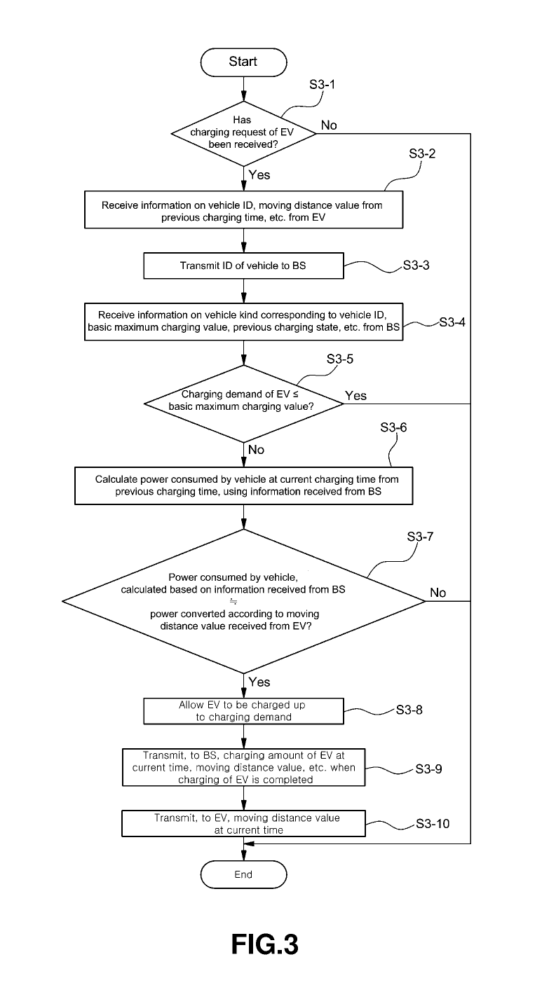

FIG. 3 is a flowchart illustrating a process of verifying a charging request of an eco-friendly vehicle (EV) 100 from an eco-friendly supply equipment (EVSE) 200 in a charging demand verification method of the EV 100 according to an exemplary embodiment of the present disclosure.

The EVSE 200 may receive the charging request from the EV 100 which requests the EVSE 200 to supply electric energy to the EV 100 (S3-1). If there is no charging request of electric energy even though the EV 100 reaches the EVSE 200, the charging demand verification of the EV may be omitted without supplying the electric energy.

However, if the EVSE 200 receives the charging request from the EV 100, which requests the EVSE 200 to supply the electric energy to the EV 100, the SECC of the SEVS 200 may receive an identification code value (PEVID) that is an ID of the vehicle, a moving distance value, a request charging value (ChargingProfileMaxPower), and the like from the EV 100 (S3-2). The moving distance value may be a moving distance value from a previous charging time to a current time or may be a value corresponding to the total moving distance of the EV 100.

The receiving of ID of the vehicle when the EV 100 requests for charging on the EVSE 200 may be an identification code value (PEVID) of Session Setup Request in 9.6.3.4.2.2 of ISO/IEC 15118. Then, the EVSE 200 may transmit the identification code value (PEVID) transmitted from the EV 100 to an SA that is the BS 300 (S3-3).

After the identification PEVID is transmitted to the SA, the EVSE 200 may receive information previously stored to correspond to the identification code value (PEVID) of the EV 100 from the SA (S3-4). The information that the EVSE 200 receives from the SA may include vehicle type information, a basic maximum charging value (ChargingProfileEntryMaxPower) and information on a previous charging state. The information on the previous charging state may become a value such as a moving distance value or charging amount at the previous charging time. The power of the corresponding EV 100 may be identified using the vehicle type information transmitted from the SA. The basic maximum charging value (ChargingProfileEntryMaxPower) may be selected as an amount where the battery of the EV 100 can be maximally charged based on ‘0’. The EVSE 200 may receive, from the SA, information on a state in which the electric energy was previously charged in the EV 100, and the like. The information may become an accumulated moving distance or a charging amount at the previous charging time.

After receiving the information corresponding to the identification code value (PEVID) of the EV 100 from the SA, the EVSE 200 in the charging demand verification method of the EV according to an exemplary embodiment of the present disclosure may compare whether the charging demand of the EV is smaller than the basic maximum charging value received from the SA (S3-5). That is, the EVSE 200 may compare the value of the charging demand (ChargingProfileMaxPower) received from the EV 100 with the basic maximum charging value (ChargingProfileEntryMaxPower) received from the SA. Specifically, the EVSE 200 identifies the basic maximum charging value (ChargingProfileEntryMaxPower) in ChargingProfile of a power delivery request item in 9.6.3.4.10.2 of the ISO/IEC 15118, and compares the identified value with the charging demand (ChargingProfileMaxPower) that is a charging value requested by the EV 100. If the charging demand (ChargingProfileMaxPower) exceeds the basic maximum charging value (ChargingProfileEntryMaxPower), the EVSE 200 denies charging of the EV 100.

However, if the charging demand (ChargingProfileMaxPower) is within the basic maximum charging value (ChargingProfileEntryMaxPower), the EVSE 200 may calculate a prediction value of power consumed by the EV 100 from the previous charging time to the current charging time, based on the information received from the SA (S3-6).

In this case, the EVSE 200 may calculate the prediction value of the power consumed by the EV 100, using mile per gallon (MPG) in the vehicle type information received from SA and the moving distance value received from the EV 100. In other words, the prediction value may be calculated by dividing the MPG into the moving distance value. In a case where the EV 100 provides the difference from the previous charging time to the current charging time as a moving distance value, the prediction value may be calculated by dividing the MPG into the moving distance value. In a case where the EV 100 provides the total accumulated moving amount as a moving distance value, the prediction value may be calculated by subtracting the accumulated moving distance value stored at the previous charging time, which is received from the SA, from the moving distance value.

Then, the EVSE 200 may compare the prediction value of the power consumed by the EV 100 with power actually consumed by the EV 100 (S3-7). The power consumed by the EV 100 may be calculated by adding a natural discharging amount of the EV 100 and power consumed by several devices in the EV 100 to the power consumed by the EV 100 during driving of the EV 100. The power actually consumed by the EV 100 may be a value equal to the value obtained by theoretically subtracting remaining electric energy amount from the charging amount.

The power consumed by the several devices in the EV 100 may be determined by adding the power consumed by all electronic devices in the EV 100 or may be determined by selecting a sample considered to maximally consume power and adding the power to the amount of the consumed power. For example, the power consumed by a multimedia or communication equipment such as a navigation equipment, an audio equipment, or an air conditioner inside the EV 100, which is operated during driving of the EV 100, may be determined as sample information in calculation of the power consumed by the several devices in the EV 100.

However, the power consumed by the several devices in the EV 100 and the natural discharging amount may not be greater than the power consumed by the EV 100 when driving the EV 100. Therefore, the power actually consumed by the EV 100 may be replaced by the power consumed by the EV 100 during the driving of the EV 100.

If the difference between the prediction value of the power consumed by the EV 100 and the power actually consumed by the EV 100 is within a predetermined error range, the EVSE 200 may charge the EV 100 up to the charging demand (S3-8). The predetermined error range may be set at an appropriate value, in consideration of the power consumed by the several devices in the EV 100 and the natural discharging amount.

If the charging of the EV 100 is completed, the EVSE 200 may transmit, to the SA, information on the amount of electric energy charged in the EV at the current time, the moving distance value of the EV 100, and the like (S3-9). The EVSE 200 may renew the moving distance value of the EV 100 by transmitting the moving distance value at the current time to the EV 100 when the charging of the EV 100 is completed (S3-10).

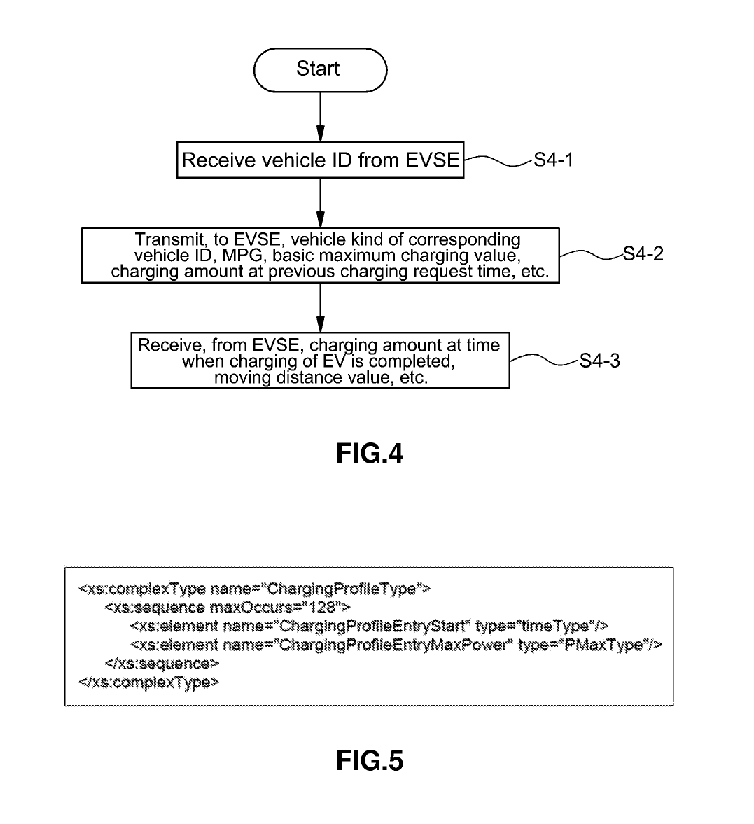

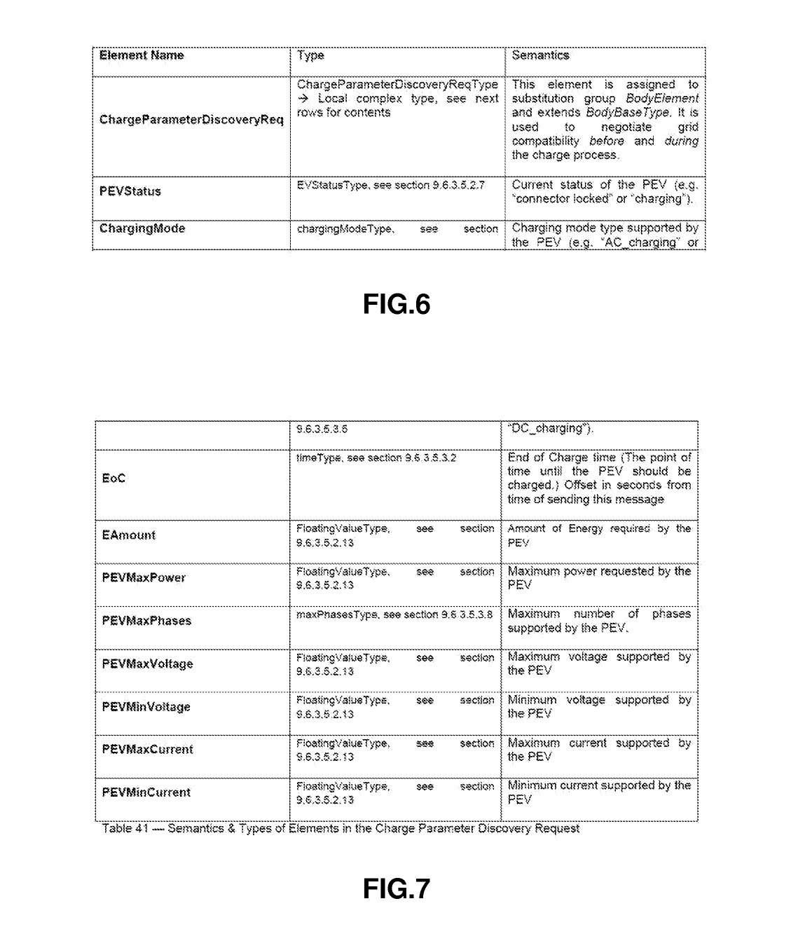

FIG. 4 is a flowchart illustrating an operation of a SA which is a BS 300.

The SA may receive the identification code value (PEVID) of EV 100, transmitted from the EVSE 200 (S4-1). If the SA receives the identification code value (PEVID) of the EV 100, transmitted from the EVSE 200, the SA may search vehicle type information of the EV 100 corresponding to the identification code value (PEVID), the basic maximum charging value (ChargingProfileEntryMaxPower), information on the charging amount at the previous charging time, etc., may extract these values, and may transmit the extracted values to the EVSE 200 (S4-2). In addition to the information that the SA transmits to the EVSE 200, other information of the EV 100, which can calculate a legal charging demand of the EV 100, may be stored in the SA. The other information of the EV 100 may also be transmitted to the EVSE 200.

Then, the SA may receive, from the EVSE 200, the charging amount at the time when the charging of the EV 100 is completed, the moving distance value, etc (S4-3).

The disclosure has been described in detail with reference to exemplary embodiments thereof. However, it will be appreciated by those skilled in the art that changes may be made in these embodiments without departing from the principles and spirit of the disclosure, the scope of which is defined in the appended claims and their equivalents.

What is claimed is:

1. A charging demand verification method of an eco-friendly vehicle (EV), the method comprising:
receiving, by an eco-friendly vehicle supply equipment (EVSE), a charging request from a communication controller of eco-friendly vehicle (EVCC);
receiving, by the EVSE, an identification code value (PEVID), a moving distance value, and a request charging value (ChargingProfileMaxPower) from the EVCC;
transmitting, by the EVSE, the received identification code value to a secondary actor (SA);
receiving, by the EVSE, vehicle type information, a basic maximum charging value (ChargingProfileEntryMaxPower), an accumulated moving distance value, and a charging amount at a previous charging time from the SA;
comparing, by the EVSE, the request charging value received from the EVCC of the EV with the basic maximum charging value received from the SA;
denying, by the EVSE, the charging request of the EV when the request charging value is greater than the basic maximum charging value, and allowing a next process to proceed when the request charging value is smaller than the basic maximum charging value;
calculating, by the EVSE, a prediction value of power consumed by the EV, using mile per gallon (MPG) of the vehicle type information received from the SA, the accumulated moving distance value at the previous charging time, and the moving distance value received from the EVCC of the EV; and
allowing, by the EVSE, the EV to be charged when the difference between the prediction value of the power consumed by the EV and power actually consumed by the EV is within a predetermined error range.

2. The method of claim 1, wherein the calculating of the prediction value of the power consumed by the EV, using the MPG of the vehicle type information received from the SA, the accumulated moving distance value at the previous charging time, and the moving distance value received from the EVCC of the EV includes calculating a difference value between the moving distance value received from the EV and the accumulated moving distance value at the previous charging time received from the SA, and calculating the prediction value of the power consumed by the EV by dividing the MPG of the vehicle type information into the difference value.

3. The method of claim 1, further comprising, after the allowing of the EV to be charged when the difference between the prediction value of the power consumed by the EV and the power actually consumed by the EV is within the predetermined error range:
transmitting, by the EVSE, the amount of power charged in the EV and a moving distance value in the charging of the EV to the SA; and
transmitting, by the EVSE, the moving distance value in the charging of the EV to the EV.

4. A charging demand verification method of an eco-friendly vehicle (EV), the method comprising:
receiving, by a secondary actor (SA), an identification code value (PEVID) transmitted from an eco-friendly vehicle supply equipment (EVSE) which charges power in the EV;
transmitting, by the SA, vehicle type information of the corresponding EV, a basic maximum charging value (ChargingProfileEntryMaxPower), an accumulated moving distance value, and a charging amount at a previous charging time to the EVSE according to the PEVID of the EV; and
receiving, by the SA, the amount of power charged in the EV and a moving distance value in the charging of the EV, transmitted from the EVSE.

5. A charging demand verification method of an eco-friendly vehicle (EV), the method comprising:
transmitting, by a communication controller of eco-friendly vehicle (EVCC) of the EV, a charging request to an eco-friendly vehicle supply equipment (EVSE);
transmitting, by the EVCC of the EV, an identification code value (PEVID), a moving distance value, and a request charging value (ChargingProfileMaxPower) to the EVSE;
allowing the EV to be charged by receiving power supplied from the EVSE;
receiving, by the EVCC of the EV, the moving distance value in the charging of the EV from the EVSE when the charging of the EV is completed; and
storing, by the EVCC of the EV the moving distance value in the charging of the EV in a memory.

6. A charging demand verification system of an eco-friendly vehicle (EV), the system comprising:
the EV configured to request electric energy to be charged therein;
an eco-friendly vehicle supply equipment (EVSE) configured to receive a charging request from a communication controller of eco-friendly vehicle (EVCC) of the EV, to decide whether the charging request requests power actually consumed by the EV, and to allow the electric energy to be supplied to the EV when the charging request is a legal charging request; and
a secondary actor (SA) configured to store vehicle type information corresponding to an identification code value (PEVID) of the EV that transmits a charging request to the EVSE, an accumulated moving distance value, and a charging amount at a previous charging time and to transmit the vehicle type information, the accumulated moving distance value, and the charging amount at the previous charging time to the EVSE according to the charging request of the EV.
